(19) United States
(12) Patent Application Publication
(10) Pub. No.: US 2026/0364625 A1
(43) Pub. Date: Nov. 19, 2026

(54) TREATMENT PLANT FOR TREATING WORKPIECES, AND METHOD FOR TREATING WORKPIECES

(71) Applicant: Dürr Systems AG, Bietigheim-Bissingen (DE)

(72) Inventors: Daniel Ackermann, Ditzingen (DE); Michael Just, Sindelfingen (DE); Frank Herre, Oberriexingen (DE); Meinhard Lutsch, Ehningen (DE)

(21) Appl. No.: 19/137,591

(22) PCT Filed: Dec. 13, 2023
(86) PCT No.: PCT/DE2023/100965

§ 371 Date: Jun. 10, 2025

(30) Foreign Application Priority Data
Dec. 16, 2022 (DE) 10 2022 133 696.4

(51) Int. Cl. B05B 13/04; B05B 15/14; B05B 16/20; B05B 16/60

(52) U.S. Cl. CPC B05B 13/0433; B05B 15/14; B05B 16/20; B05B 16/60

(57) ABSTRACT

The present invention relates to a treatment plant (100) for treating workpieces (102), in particular a painting plant (104) for painting vehicle bodies (106), wherein at least one access region (120, 122, 124, 126, 128, 130, 132, 134, 142, 144, 146) is provided, which is arranged at least partially outside or inside at least one treatment region (110, 112, 114, 136, 138, 140), wherein fresh air and/or circulating air can be fed from the at least one treatment region (110, 112, 114, 136, 138, 140) to the at least one access region (120, 122, 124, 126, 128, 130, 132, 134, 142, 144, 146) and can be conveyed, in particular conveyed back, into the at least one treatment region.

### RELATED APPLICATION

This application is a national phase of international application No. PCT/DE2023/100965 filed on Dec. 13, 2023, and claims the benefit of German application No. 10 2022 133 696.4 filed on Dec. 16, 2022, which are incorporated herein by reference in their entirety and for all purposes.

### FIELD OF DISCLOSURE

Examples disclosed herein relate to a treatment plant for treating workpieces. A treatment plant of this kind can be provided, for example, for treating vehicle bodies. In particular, a treatment plant for treating workpieces can be a painting plant for painting vehicle bodies. Furthermore, examples disclosed herein relate to a corresponding method for treating workpieces.

From practical experience, it is known that action devices such as painting robots, which are generally designed as a robot arm, are used in painting regions of a treatment plant. These painting robots are usually equipped with one or more rotational atomizers, paint guns or other treatment tools which have to be serviced and/or cleaned at regular intervals to ensure high-quality treatment of the workpieces.

In the case of a rotational atomizer, for example, the cleaning of the bell cup or of the outer charging ring is necessary, especially when changing colors or after relatively long production times. It may also be necessary to exchange the outer charging ring.

For such servicing and/or cleaning processes, the treatment of the workpiece concerned is interrupted.

In particular, the servicing and maintenance of the action devices of a painting region is carried out from what are referred to as access regions or servicing regions, which are arranged in the respective painting region.

On the one hand, the safety technology associated therewith upstream and downstream of the painting region through which the workpieces are conveyed is complex in order above all to avoid crush risks. Moreover, additional space has to be provided for a user for entry to the painting region in order to avoid subjecting said user to risks.

On the other hand, some of the action devices must be guided on rails in order to ensure accessibility via the access regions, in particular during treatment. For this purpose, the corresponding rails are generally arranged on the side walls of the paint booth of a painting region and, as a result, prevent a direct or uninterrupted view into the paint booth.

### BACKGROUND

WO 2021/063443 and WO 2021/063444 have already disclosed a treatment plant for treating workpieces, having a treatment region for receiving workpieces to be treated and a plurality of action devices for carrying out one or more actions on the workpieces to be treated. The treatment plant comprises at least one access region, from which and/or at which the one or more action devices are accessible in a state for access. The access region is spatially separated from the actual treatment region and is arranged in a stationary manner within the treatment space region, preferably in a corner region of the treatment space.

By virtue of the arrangement of the one or more access regions arranged completely in the treatment region, the cross-sectional area of the treatment region which runs perpendicularly to the conveying direction of the workpieces is reduced, and this entails an additional outlay on safety technology.

### SUMMARY

It is therefore the underlying object of examples disclosed herein to provide a treatment plant which is of simple construction and can be used efficiently.

According to examples disclosed herein, this object is achieved by means of a treatment plant having the features according to claim 1.

The treatment plant is, in particular, a painting plant for vehicle bodies.

The treatment plant comprises the following:
a conveying direction, along which the workpieces can be conveyed through the treatment plant;
at least one treatment region for receiving workpieces to be treated;
one or more action devices for carrying out one or more actions on the workpieces to be treated; and
at least one access region, from which and/or at which the one or more action devices are accessible,
   wherein the at least one access region is arranged at least partially outside or inside the at least one treatment region, and wherein fresh air and/or circulating air can be fed from the at least one treatment region to the at least one access region and can be conveyed, in particular conveyed back, into the at least one treatment region.

The concept underlying examples disclosed herein is that it is possible, by means of an alternative arrangement of the access regions from which the action devices are accessible, on the one hand to reduce the number of access regions and, on the other hand, to counteract a reduction, at the level of the access regions, in the cross-sectional area which runs perpendicularly to the conveying direction, thus making it possible inter alia to minimize the crush risk zones and the associated safety technology that is required. Moreover, an improved concept for routing air through the access regions according to examples disclosed herein makes it possible, for example, to avoid the need to provide separate round ducts for feeding air to the individual access regions.

A treatment region is, for example, a machining region and/or coating region for machining and/or treating workpieces.

An action to be carried out on the workpiece is to be treated is, in particular, a treatment action, e.g. a coating process and/or treatment process.

In particular, provision can be made for the one or more action devices to be accessible to a person, e.g. a worker, and/or by machine, in particular for a servicing machine and/or fitting machine, from the at least one access region and/or at the at least one access region.

It is preferable if one or more, in particular all, of the action devices are arranged permanently or at least almost permanently and/or completely or at least almost completely within the treatment region, in particular between the two side walls of the treatment region.

The action devices are preferably not removed from the treatment region in order to carry out servicing actions and/or fitting actions.

All the action devices preferably remain within the treatment region while treatment processes are being carried out on the workpieces.

The treatment plant preferably comprises a conveying device for conveying workpieces, wherein the workpieces can preferably be conveyed in a conveying direction into the treatment region, through the treatment region and/or out of the treatment region.

Preferably, at least one access region is assigned to a plurality of action devices. It may be advantageous if each access region is assigned to a plurality of action devices.

It may be advantageous if one or more action devices each have one or more action elements, in particular one or more application elements and/or handling elements.

One or more of the action elements, in particular all of the action elements, are preferably partially and/or completely and/or simultaneously and/or successively movable into one or more access regions and/or toward one or more access regions.

Provision can furthermore be made for the at least one access region to be spatially separated from the at least one treatment region.

By virtue of the spatial separation of the two regions, dedicated air routing can be set up for each one.

It is furthermore advantageous if the at least one treatment region is assigned at least two, preferably precisely two, access regions.

By means of a lateral arrangement that is central in relation to the conveying direction it is possible preferably for a plurality, in particular all, of the action devices on one side of the associated treatment region to be assigned to one access region.

It is advantageous if the fresh air and/or the circulating air can be fed by means of a fan and/or of a duct system to the at least one access region.

In another embodiment of examples disclosed herein, provision can be made for the air to be discharged horizontally and/or vertically from the at least one access region.

Provision can furthermore be made for the at least one access region to comprise at least one access opening to at least one treatment region, through which opening one or more action devices are accessible.

Via the access opening, exchange, changing or setting down of elements of the action devices, in particular of the action elements thereof, can take place.

In this description and the appended claims, the term “exchange part” should be understood to mean an exchangeable or interchangeable element of the action device which is to be exchanged, changed or set down before, during or after treatment of the workpieces. For example, an external charge electrode of a rotary atomizer of a painting robot arm.

Provision can furthermore be made for the at least one access opening to comprise a movable disk, in particular an automatically movable disk, or to be designed as such.

The provision of a movable disk eliminates the need for an air curtain device in the region of the access opening to atmospherically separate an air curtain of the treatment region and the access region.

Alternatively or in addition, the access opening can comprise a roller shutter mechanism or can be designed as such.

It is furthermore advantageous if the at least one access opening comprises a turntable, a drawer system or a deposition table, via which exchange parts, in particular electrode rings or bell cups or even entire atomizers, can be transferred between the at least one access region and the one or more action devices of at least one treatment region.

It is advantageous if the one or more action devices are arranged at a fixed location in the respective treatment region or can be moved along a guide device, in particular a rail device, within the respective treatment region.

Preferably, a plurality, in particular all, of the action devices are arranged at a fixed location in the respective treatment region, thereby not only making it possible to eliminate the guide devices but also maintaining the view into the treatment region.

In another embodiment of examples disclosed herein, provision can be made for the at least one treatment region to have a walk-on floor, in particular a grid-type floor, above and/or below which the air from the at least one access region can be conveyed, in particular conveyed back, into the at least one treatment region.

Provision can furthermore be made for the at least one access region to have a door, via which the at least one access region can be entered.

Accordingly, a worker can enter the access region through the door in order to service, maintain, repair, clean or the like, the assigned action devices from the access region.

If only fresh air is fed in, the worker can enter the access region without protective equipment, whereas, if circulating air is fed in from one of the treatment regions, protective equipment is required.

It is furthermore advantageous if the fresh air and/or the circulating air can be fed in above the door via a feed region.

It is advantageous if the feed region comprises a plenum for homogeneous introduction of air into the access region and/or a filter device, in particular a filter ceiling, for filtering the fresh air and/or circulating air fed in.

In another embodiment of examples disclosed herein, provision can be made for the at least one access region not to be enterable and to have at least one interchange opening for removing exchange parts from the at least one access region and/or introducing them into the at least one access region.

Provision can furthermore be made for the treatment plant to comprise at least two treatment regions, which each comprise one or more action devices and which are arranged in series and/or in parallel with one another in relation to the conveying direction, wherein at least one access region is assigned to at least two treatment regions.

In other words, the treatment plant can comprise two or more treatment lines, which comprise treatment regions arranged in series in the conveying direction. The treatment lines are preferably aligned parallel to one another, and access regions can be arranged between the lines, thereby enabling action devices in both lines to be assigned to an access region arranged between the lines.

The object of examples disclosed herein is furthermore achieved by a method for treating workpieces, in particular for painting vehicle bodies.

The method according to examples disclosed herein comprises the following steps:
feeding fresh air and/or circulating air from a treatment region into an access region;
opening an access opening of the access region;
servicing one or more action devices of the treatment region via the access opening of the access region
closing the access opening of the access region; and
conveying the air of the access region, in particular conveying it back, into the treatment region.

Provision can furthermore be made for the access opening of the access region to comprise a turntable, a drawer system or a deposition table, via which exchange parts of the one or more action devices are changed during the servicing process.

It is furthermore advantageous if the air from the access region is discharged horizontally and/or vertically and is fed to the treatment region above and/or below a walk-on floor, in particular a grid-type floor, of the treatment region.

The method preferably has individual or several of the features and/or advantages described in connection with the treatment plant. The treatment plant furthermore preferably has individual or several of the features and/or advantages described in connection with the method.

Further preferred features and/or advantages of the invention form the subject matter of the following description and the graphical illustration of exemplary embodiments.

### BRIEF DESCRIPTION OF THE DRAWINGS

FIG. 1 shows a schematic illustration of a first embodiment of a treatment plant according to examples disclosed herein;

FIG. 2 shows a schematic illustration of a second embodiment of a treatment plant according to examples disclosed herein; and

FIG. 3 shows a schematic illustration of an access region according to the prior art;

FIG. 4 shows a schematic illustration of a first embodiment of an access region according to examples disclosed herein;

FIG. 5 shows a schematic illustration of a second embodiment of an access region according to examples disclosed herein; and

FIG. 6 shows a schematic illustration of a third embodiment of an access region according to examples disclosed herein.

Elements which are identical or have the same effect functionally are provided with the same reference signs in all the figures.

### DETAILED DESCRIPTION OF THE DRAWINGS

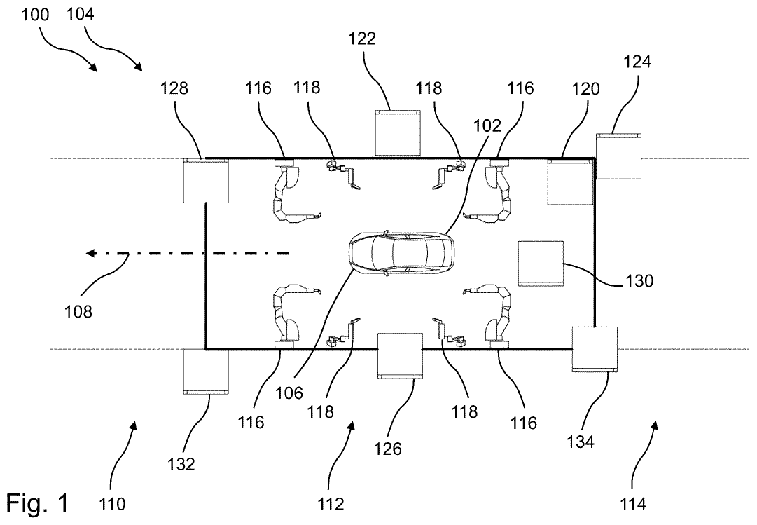

A first embodiment of a treatment plant designated 100 as a whole, which is illustrated in FIG. 1, is used to treat workpieces 102.

The treatment plant 100 is, in particular, a painting plant 104 for painting vehicle bodies 106.

The workpieces 102 are conveyed along a conveying direction 108 in the treatment plant 100.

The treatment plant 100 in the first embodiment in FIG. 1 comprises three treatment regions 110, 112, 114, which are arranged in series in the conveying direction 108.

In the treatment region 112 arranged in the center in FIG. 1, first action devices 116 and second action devices 118 are arranged laterally with respect to the workpiece 102, wherein the first and the second action device 116, 118 are each arranged symmetrically with respect to the conveying direction 108.

The first and the second action devices 116, 118 are, in particular, painting robots in the form of robot arms, preferably six-axis robot arms.

Furthermore, the treatment plant 100 comprises at least one of the possible access regions 120 to 134, from which and/or at which one or more action devices 116, 118 are accessible to enable these to be serviced, maintained and/or repaired.

A number of possibilities for the arrangement of an access region are illustrated in FIG. 1 and are presented in brief below, wherein reference is made primarily, by way of example, to treatment region 112. Accordingly, the possible arrangements can be transferred to each treatment region of the treatment plant 100, and likewise apply to these.

The arrangement of access region 120 corresponds to the arrangement previously known from the prior art, i.e. completely within the treatment region 110 in one of the four region corners, and therefore the cross-sectional area of the treatment region 110, which runs transversely to the conveying direction 108, is correspondingly reduced there. The cross-sectional area reduced by the transverse dimension of access region 120 entails, inter alia, an increased number of crush risk zones, for which reason additional safety systems, such as light barriers or swing doors, should be provided.

One access region 122 can be arranged completely outside treatment region 112 and centrally between the action devices 116, 118 on the corresponding side of treatment region 112.

One access region 124 can be arranged completely outside treatment region 112 and at least partially outside treatment region 114; in relation to the latter, in particular, in the region of one of the corners adjoining treatment region 112.

One access region 126 can be arranged partially outside treatment region 112, between the action devices 116, 118 on one side of treatment region 112.

By virtue of the arrangement of access regions 122 and 126, in particular, there is the possibility that just two access regions per treatment region will be required, whereas previously, in the prior art, four access regions 120 were arranged at the four corners of the respective treatment region, and this was associated with a considerable reduction in the cross-sectional area in the entry and exit regions of the respective treatment region.

Arrangement outside or at least partially outside the respective treatment region, as in the case, for example, of access regions 122, 124, 126, accordingly results in a significantly small, or even no, reduction in the associated cross-sectional area of the respective treatment region.

One access region 128 can be arranged between treatment regions 110 and 112 or, alternatively, between treatment regions 112 and 114; in this case, it is arranged completely within the respective treatment region, at the corresponding transition.

As a result, it is possible to assign action devices 116, 118 from treatment regions 110, 112 to access region 128 in FIG. 1.

One access region 130 can be arranged at an arbitrary location within treatment region 112. Such an arrangement should preferably be harmonized with the conveying direction (not illustrated), along which the workpieces 102 are conveyed through the treatment plant 100, that is to say, in particular, through treatment regions 110, 112, 114, and the arrangement of the action devices 116, 118.

One access region 132 can be arranged on the outside between two treatment regions, i.e. at the transition between these.

As a result, it is possible to assign action devices 116, 118 from treatment regions 110, 112 to access region 132 in FIG. 1.

One access region 134 can be arranged at the transition between two treatment regions in such a way that it is arranged at least approximately in equal proportions in the treatment regions and outside said regions.

As a result, it is possible to assign action devices 116, 118 from treatment regions 112, 114 to access region 134 in FIG. 1.

Access regions 122, 124, 126 are preferred arrangement possibilities for access regions of a new treatment plant to be set up or a treatment plant to be configured, whereas access regions 120, 128, 130 are arrangement possibilities for access regions of an existing plant.

The action devices 116, 118 are either arranged at a fixed location in the respective treatment region or can be moved along a guide device (not illustrated), e.g. a rail device, preferably horizontally and/or vertically in a linear manner.

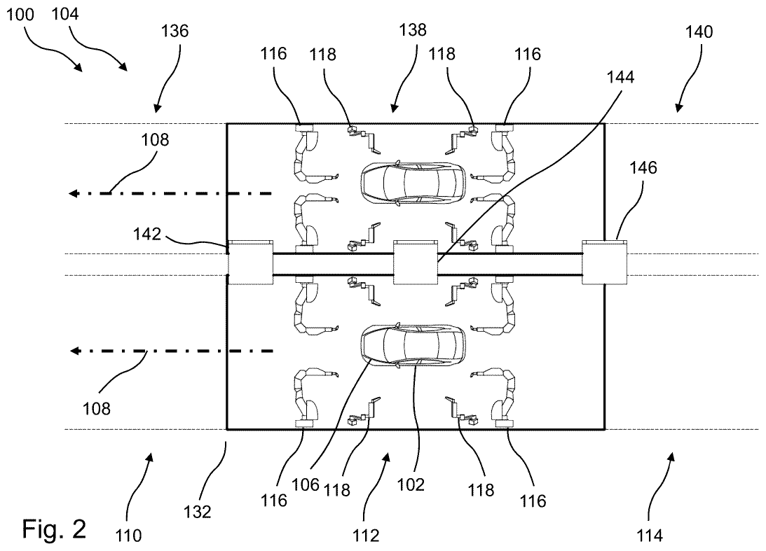

FIG. 2 illustrates a second embodiment of a treatment plant 100 according to examples disclosed herein, in which a second treatment line which comprises treatment regions 136, 138, 140 arranged in series in the conveying direction 108. The second treatment line is arranged parallel to the first treatment line, which comprises treatment regions 110, 112, 114.

The mutually adjoining, parallel treatment regions 112, 138 illustrated in FIG. 2 are preferably equipped identically with action devices 116, 118.

Three other possibilities for arranging access regions are illustrated in FIG. 2.

One access region 142 can be arranged between two parallel, mutually adjoining treatment regions, such as regions 112, 138, and preferably projects at least partially into them.

As a result, it is possible to assign action devices 116, 118 from treatment regions 112, 138 to access region 142 in FIG. 2.

One access region 144 can be arranged centrally, with respect to the conveying direction 108, between two parallel, mutually adjoining treatment regions, such as regions 112, 138, and preferably projects at least partially into them. Furthermore, the access region is preferably arranged centrally between the action devices 116, 118 of the relevant region sides.

As a result, it is possible to assign action devices 116, 118 from treatment regions 112, 138 to access region 144 in FIG. 2.

One access region 146 can be arranged between four adjacent treatment regions of the parallel treatment lines, i.e. on the adjacent transitions between two in-series treatment regions of the two treatment lines, and preferably projects at least partially into them.

As a result, it is possible to assign action devices 116, 118 from treatment regions 112, 114, 138, 140 to access region 146 in FIG. 2.

The possible access regions 120, 122, 124, 126, 128, 130, 132, 134, 142, 144 and 146 are preferably spatially separated from the relevant treatment regions.

It should be understood that, in the case of central arrangement of the access regions, as in the case of access regions 122, 126, 144 in the first and second embodiment in FIGS. 1 and 2, the action devices 116, 118 of one complete side of the relevant treatment region or those of the two relevant adjacent treatment region sides can be assigned to the centrally arranged access region.

It should furthermore be understood that the different access regions shown can be combined with one another, thus enabling the available setup area of the treatment plant 100 to be taken into account in the arrangement of the access regions required for each treatment region.

Thus, in the first embodiment in FIG. 1, for example, it is possible, for the purpose of servicing, maintenance and repair of the action devices 116, 118 of treatment region 112, to provide an access region 122 which is arranged to the right of the workpiece 102, outside treatment region 112, in relation to the conveying direction 108 (that is to say above region 112 with reference to FIG. 1), to which the action devices 116, 118 arranged at the top in FIG. 1, that is to say to the right of the workpiece 102 in relation to the conveying direction 108, are assigned.

In addition, two access regions 134 can be provided, of which the first is arranged in the transitional region between treatment regions 110, 112, and the second, as illustrated in FIG. 1, is arranged in the region of the transition between the treatment regions 112, 114, wherein, logically, both access regions are arranged to the left of the workpiece 102 in relation to the conveying direction 108.

Accordingly, the action devices 116, 118 that are at the front in the conveying direction 108, that is to say the devices on the left in FIG. 1, on the lower side of region 112, are assigned to the first access region 134 and, consequently, the action devices 116, 118 at the rear in the conveying direction 108 are assigned to the second access region.

In addition, action devices 116, 118 or the like on the side of the treatment region 110 which is on the left in relation to the conveying direction 108 can be assigned to the first access region 134, and action devices 116, 118 or the like on the side of the treatment region 114 which is on the left in relation to the conveying direction 108 can be assigned to the second access region 134.

Thus, in the example described, all the action devices 116, 118 of treatment region 112 can be assigned to just three access regions.

Similarly, it is possible, for example, for all the action devices 116, 118 in FIG. 2 of the treatment regions 112, 138 to be assigned to two access regions 122, of which one is arranged above region 138 and one is arranged below region 112 with reference to FIG. 2, and to one access region 144, which is arranged in the manner illustrated in FIG. 2, as a result of which just three access regions are required for all the action devices 116, 118 of the two regions 112, 138, which three access regions together reduce the affected cross-sectional area of regions 112, 138 to a significantly lesser extent in comparison with the prior art.

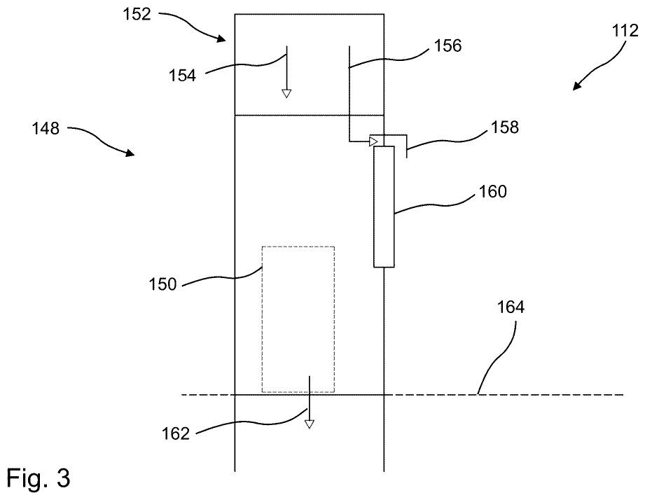

FIG. 3 illustrates an access region 148 in a schematic side view, which corresponds to the prior art and which is arranged completely within a treatment region.

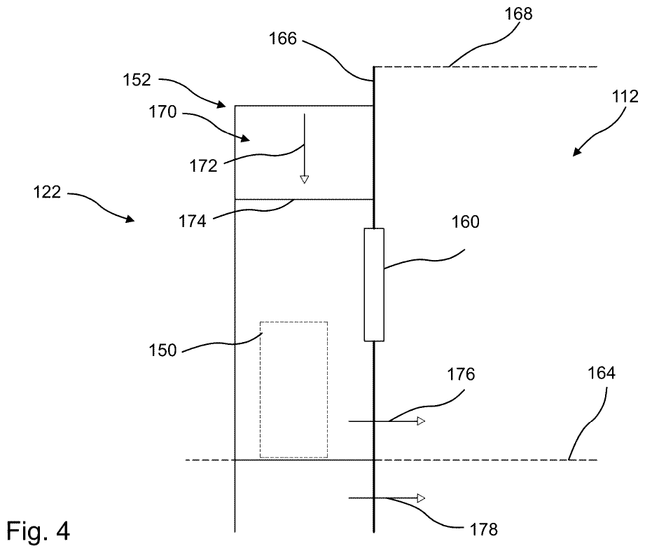

In FIG. 3, by way of example, the prior-art access region 148 illustrated is arranged in treatment region 112 of FIGS. 1 and 2. In FIGS. 4 to 6, which follow, it is also assumed that the respectively illustrated access region is arranged in or at treatment region 112.

The illustrated access region 148 comprises a door 150, via which it is possible for a user to enter the access region.

Above the door 150, access region 148 comprises a feed region 152, in which a fan (not illustrated) is arranged, which supplies a round duct 154 and a round duct 156 with fresh air.

Round duct 154 feeds fresh air to access region 148, whereas round duct 156 supplies an air curtain device 158 with fresh air.

The round ducts 154, 156 each have a throttle valve, by means of which the respective fresh air supply can be subjected to open-loop and/or closed-loop control.

Access region 148 furthermore comprises an access opening 160, via which the action devices 116, 118 of treatment region 112 which is adjacent thereto on the right-hand side are accessible.

In the region of the access opening 160, it is possible to arrange a deposition table, or the access opening 160 can comprise a deposition table, via which exchange parts of the action devices 116, 118 can be exchanged, serviced, repaired or cleaned.

By means of the air curtain device 158, a fresh air curtain is formed in front of the access opening 160, separating the circulating air in treatment region 112 atmospherically from the air in access region 148.

The air from access region 148 is discharged from access region 148 vertically via an exhaust air duct 162 and is, for example, fed back to treatment region 112 below a grid-type floor 164 so that it can be mixed into the circulating air of treatment region 112.

FIG. 4 illustrates a first embodiment of an access region according to examples disclosed herein in a schematic side view, which access region can likewise be entered via a door 150 and has a modified air duct.

The access region illustrated in FIG. 4 is preferably the access region 122 illustrated in FIG. 1, which is arranged at least approximately completely outside treatment region 112.

However, the statements which follow can be applied mutatis mutandis to the other access regions which are arranged at least partially outside one or more treatment regions and which have been described above in conjunction with FIGS. 1 and 2.

Access region 122 is spatially separated from treatment region 112 by a side wall 166, which is delimited vertically at the bottom by the grid-type floor 164 and at the top by a ceiling 168.

Fresh air and/or circulating air can be fed from treatment region 112 to feed region 152 by means of a fan (not illustrated) and/or a duct system (not illustrated).

The feed region 152 of access region 122 has a plenum 170, as a result of which the air 172 fed in can be distributed uniformly and then flows vertically through access region 122 via an optional filter ceiling 174 of feed region 152.

The access opening 160 comprises a movable disk, preferably an automatically movable disk.

The exhaust air from access region 122 is discharged horizontally from access region 122 via an exhaust air duct 176 and/or an exhaust air duct 178 and is fed back into treatment region 112 above and/or below the level of the grid-type floor 164, where it is mixed into the circulating air.

An access region 122 of this kind is suitable particularly for new treatment plants 100.

Modified air routing of this kind also makes it possible to supply a plurality of access regions 122 or, in a manner similar to a fan, in feeding in the air.

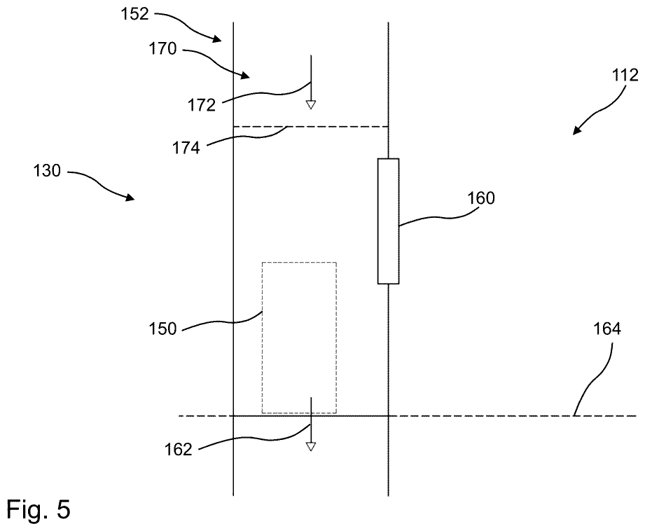

FIG. 5 illustrates a second embodiment of an access region according to examples disclosed herein in a schematic side view, which access region can likewise be entered via a door 150 and has a modified air duct.

The access region illustrated in FIG. 5 is preferably the access region 130 illustrated in FIG. 1, which is arranged at least approximately completely within treatment region 112.

However, the statements which follow can be applied mutatis mutandis to the other access regions which are arranged within a treatment region and which have been described above in conjunction with FIGS. 1 and 2.

The feed region 152 of the access region 130 illustrated is open at the top, and therefore circulating air which is flowing through treatment region 112, in particular vertically, can already likewise flow through access region 130.

Here, the exhaust air duct 162 carries the air from access region 130 vertically out of the latter and preferably feeds it back into treatment region 112 from below the grid-type floor 164.

The use of an access region 130 of this kind is recommended, in particular, in the case of existing treatment plants 100, which already have a fresh-air and exhaust-air concept.

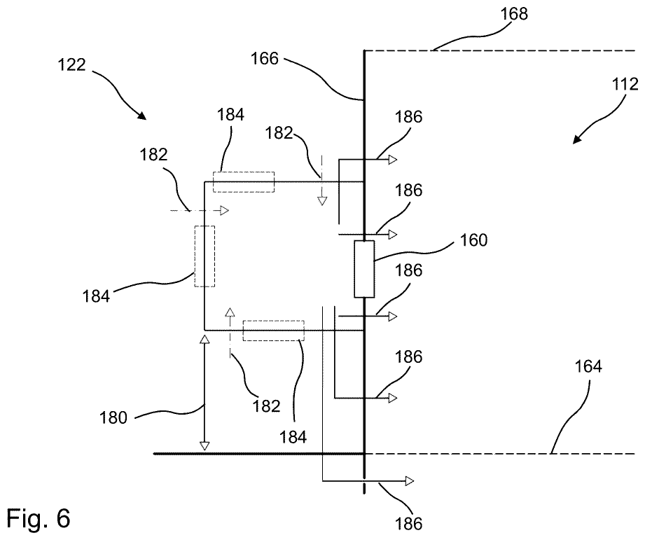

FIG. 6 illustrates a third embodiment of an access region according to examples disclosed herein in a schematic side view, it not being possible to enter said access region.

The access region illustrated in FIG. 5 is preferably the access region 122 illustrated in FIG. 1, which is arranged at least partially outside treatment region 112.

However, the statements which follow can be applied mutatis mutandis to the other access regions which are arranged partially outside one or more treatment regions and which have been described above in conjunction with FIGS. 1 and 2.

The height 180 of the access region 122 in FIG. 6 above the level of the grid-type floor 164 can be set in a variable manner.

The figure illustrates three illustrative air feeds 182 for fresh air and/or circulating air from one or more treatment regions, wherein an air feed 182 from above into access region 122 is preferred.

Access region 160 furthermore comprises a turntable, a drawer system or a deposition table, via which, for example, exchange parts of the action devices 116, 118 of treatment region 112 can be transferred between non-enterable access region 122 and the corresponding action device 116, 118.

The non-enterable access region 122 in FIG. 6 furthermore has an interchange opening 184, wherein various possible positions for an interchange opening of this kind are indicated in FIG. 6.

Via the interchange opening 184, the exchange parts or the like can be removed from access region 122, or new parts can be inserted into access region 122, thus enabling them to be transferred via the access opening 160 to the action devices 116, 118.

The exhaust air from the non-enterable access region 122 in FIG. 6 can be discharged horizontally or vertically via one or more exhaust air ducts 186, and can be fed back into treatment region 112 above and/or below the grid-type floor 164.

List of reference signs

| | |
|---|---|
| 100 | treatment plant |
| 102 | workpieces |
| 104 | painting plant |
| 106 | vehicle bodies |
| 108 | conveying direction |
| 110 | treatment region |
| 112 | treatment region |
| 114 | treatment region |
| 116 | action device |
| 118 | action device |
| 120 | access region |
| 122 | access region |
| 124 | access region |
| 126 | access region |
| 128 | access region |
| 130 | access region |
| 132 | access region |
| 134 | access region |
| 136 | treatment region |
| 138 | treatment region |
| 140 | treatment region |
| 142 | access region |
| 144 | access region |
| 146 | access region |
| 148 | prior-art access region |
| 150 | door |
| 152 | feed region |
| 154 | round duct |
| 156 | round duct |
| 158 | air curtain device |
| 160 | access opening |
| 162 | exhaust air duct |
| 164 | grid-type floor |
| 166 | side wall |
| 168 | ceiling |
| 170 | plenum |
| 172 | air fed in |
| 174 | filter ceiling |
| 176 | exhaust air duct |
| 178 | exhaust air duct |
| 180 | height of the access region |
| 182 | air feed duct |
| 184 | interchange opening |
| 186 | exhaust air duct |

1. A treatment plant for treating workpieces, optionally a painting plant for painting vehicle bodies, comprising:
a conveying direction, along which the workpieces can be conveyed through the treatment plant;
at least one treatment region for receiving workpieces to be treated;
one or more action devices for carrying out one or more actions on the workpieces to be treated; and
at least one access region, from which and/or at which the one or more action devices are accessible,
wherein the at least one access region is arranged at least partially outside or inside the at least one treatment region, and wherein fresh air and/or circulating air can be fed from the at least one treatment region to the at least one access region and can preferably be conveyed, in particular optionally conveyed back, into the at least one treatment region.

2. The treatment plant as claimed in claim 1, wherein the at least one access region is spatially separated from the at least one treatment.

3. The treatment plant as claimed in claim 1, wherein the at least one treatment region is assigned at least two, preferably precisely two, access regions.

4. The treatment plant as claimed in claim 1, wherein the fresh air and/or the circulating air can be fed by a fan and/or of a duct system to the at least one access region.

5. The treatment plant as claimed in claim 1, wherein the air can be discharged horizontally and/or vertically from the at least one access region.

6. The treatment plant as claimed in claim 1, wherein the at least one access region includes at least one access opening to at least one treatment region, through which opening one or more action devices are accessible.

7. The treatment plant as claimed in claim 6, wherein the at least one access opening includes a movable disk, in particular an automatically movable disk, or is designed as such.

8. The treatment plant as claimed in claim 6, wherein the at least one access opening includes a turntable, a drawer system or a deposition table, via which exchange parts, optionally electrode rings, can be transferred between the at least one access region and the one or more action devices of at least one treatment region.

9. The treatment plant as claimed in claim 1, wherein the one or more action devices are arranged at a fixed location in the respective treatment region or can be moved along a guide device, optionally a rail device, within the respective treatment region.

10. The treatment plant as claimed in claim 1, wherein the at least one treatment region has a walk-on floor, optionally a grid-type floor, above and/or below which the air from the at least one access region can be conveyed into the at least one treatment region.

11. The treatment plant as claimed in claim 1, wherein the at least one access region has a door, via which the at least one access region can be entered.

12. The treatment plant as claimed in claim 11, wherein the fresh air and/or the circulating air can be fed in above the door via a feed region.

13. The treatment plant as claimed in claim 12, wherein the feed region includes a plenum for homogeneous introduction of air into the access region and/or a filter device, optionally a filter ceiling, for filtering the fresh air and/or circulating air fed in.

14. The treatment plant as claimed in claim 1, wherein the at least one access region is not enterable and has at least one interchange opening for removing exchange parts from the at least one access region and/or introducing them into the at least one access region.

15. The treatment plant as claimed in claim 1, wherein the treatment plant includes at least two treatment regions, which each include one or more action devices and which are arranged in series and/or in parallel with one another in relation to the conveying direction, wherein at least one access region is assigned to at least two treatment regions.

16. A method for treating workpieces, optionally for painting vehicle bodies, the method comprising:
feeding fresh air and/or circulating air from a treatment region into an access region;
opening an access opening of the access region;
servicing one or more action devices of the treatment region via the access opening of the access region;
closing the access opening of the access region; and
conveying the air of the access region, optionally, into the treatment region.

17. The method as claimed in claim 16, wherein the access opening of the access region includes a turntable, a drawer system or a deposition table, via which exchange parts of the one or more action devices are changed during the servicing process.

18. The method as claimed in claim 16, wherein the air from the access region is discharged horizontally and/or vertically and is fed to the treatment region above and/or below a walk-on floor, in particular a grid-type floor, of the treatment region.
